(19) United States
(12) Patent Application Publication
(10) Pub. No.: US 2018/0257625 A1
(43) Pub. Date: Sep. 13, 2018

(54) BRAKE CONTROL DEVICE, TRAVELING VEHICLE, BRAKE DRIVING METHOD, AND PROGRAM

(71) Applicant: Sharp Kabushiki Kaisha, Osaka (JP)

(72) Inventor: Yoichi FUJIWARA, Sakai City (JP)

(21) Appl. No.: 15/915,230

(22) Filed: Mar. 8, 2018

(30) Foreign Application Priority Data
Mar. 10, 2017 (JP) 2017-045900

(51) Int. Cl. B60T 13/74; F16D 59/00; H02P 15/00

(52) U.S. Cl. CPC B60T 13/748; F16D 2121/22; H02P 15/00; F16D 59/00

(57) ABSTRACT

A brake control device of a non-excitation actuation type mounted on a traveling vehicle to release an electromagnetic brake upon energization of an electromagnet includes a current quantity control unit which controls a current quantity to be supplied to the electromagnet. The current quantity control unit performs control by an attraction voltage to be applied when the electromagnetic brake is released, a retention voltage to be applied to maintain a release state, and a re-attraction voltage to be applied to readjust a retention state.

### BACKGROUND

### 1. Field

The present disclosure relates to a brake control device, traveling vehicle, brake driving method, and program.

### 2. Description of the Related Art

Electromagnetic brakes have been used as brakes for braking movable bodies such as electric wheelchairs and motor vehicles. In an electromagnetic brake, a brake pad is pressed by electric power, spring pressure, or the like onto a disk or the like rotating with a wheel to cause a friction force, thereby decelerating the movable body. In this electromagnetic brake, a non-excitation type is adopted to ensure safety. In this type, when electric power is not supplied, the brake pad is pressed onto the disk. In an energized state supplied with electric power, the brake pad is separated from the disk for brake release (for example, refer to Japanese Unexamined Patent Application Publication No. 2000-189464).

FIG. 21 is a schematic sectional view of the structure of a non-excitation electromagnetic brake suggested in related art. A shaft 1, an outer disk 2, an armature 3, a pad 4, an electromagnet 5, and springs 6 and 7 are arranged inside a housing of an electromagnetic brake 10.

The shaft 1 is a rod-shaped member extending from the wheel shaft of the movable body, and rotates with the wheel about the center axis of the shaft 1 as a rotation center. The outer disk 2 is a disk-shaped member fixed to the tip of the shaft 1, and rotates integrally with the shaft 1. The armature 3 is a disk-shaped member disposed inside of the outer disk 2, and is configured of a magnetic material so as to be attracted by a magnetic force occurring at the electromagnet 5 to be movable along the rotation axis of the shaft 1.

The pad 4 is a member attached to a portion near an outer periphery of a surface of the armature 3 on an outer disk 2 side, and is configured of a material where a high friction force occurs when coming in contact with the outer disk 2. The electromagnet 5 is supplied with electric power from a brake control device to generate a magnetic force, which attracts the armature 3 and the pad 4 to separate them from the outer disk 2. The spring 6 is a spring wound around the outside of the shaft 1, and presses the outer disk 2 to a direction of the end of the shaft 1. The spring 7 is a spring arranged along the rotation axis of the shaft 1, and presses the armature 3 to a direction of the outer disk 2.

FIG. 22A and FIG. 22B depict output voltage from the brake control device to an electromagnet 5, in which FIG. 22A depicts a case of retention by static voltage and FIG. 22B depicts a case of retention by pulse voltage. When no voltage is outputted from the brake control device to the electromagnet 5, no current flows through the electromagnet 5 and no magnetic force occurs. Thus, the armature 3 is pressed by the spring 7 to the direction of the outer disk 2, the pad 4 comes into contact with the outer disk 2 to generate a friction force, and a force is applied to a direction of stopping the rotation of the outer disk 2 to apply brakes, thereby decelerating the movable body.

When a predetermined voltage value is outputted from the brake control device to the electromagnet 5, a current flows through the electromagnet 5 to generate a magnetic force. The armature 3 is attracted by the magnetic force to a direction of the electromagnet 5, and moves against the elastic force of the spring 7 to a direction of being separated from the outer disk 2. This causes the pad 4 and the outer disk 2 to be separated from each other, decreases the friction force applied to the outer disk 2 to cause a brake release state, and causes the outer disk 2 and the shaft 1 to be rotatable with the wheel of the movable body.

In order to continue the motion of the movable body, a state of separation between the outer disk 2 and the pad 4, that is, a brake release state, has to be maintained. Thus, a voltage for maintaining the separation state is outputted from the brake control device to the electromagnet 5. In attracting operation at the time of break release, the armature 3 and the electromagnet 5 are separated with a gap g1 as depicted in FIG. 21. The magnetic force for moving the armature 3 against the elastic force of the spring 7 is large, and the voltage supplied to the electromagnet 5 is at maximum. After the attracting operation is completed, the armature 3 is near the electromagnet 5. Thus, a gap between the armature 3 and the electromagnet 5 is smaller than the gap g1, and a magnetic force for maintaining this state is smaller than that at the time of attracting operation.

In the example depicted in FIG. 22A, a retention voltage smaller than the voltage at the time of attraction is steadily supplied to the electromagnet 5 after the attracting operation is completed. In the example depicted in FIG. 22B, a pulse voltage similar to the voltage at the time of attraction is supplied to the electromagnet 5 after the attracting operation is completed. In this manner, with the retaining operation continuing after the attracting operation, the state in which the armature 3 and the pad 4 are separated from the outer disk 2 is maintained, and the brake release state is maintained.

In this weak excitation driving of applying a low retention voltage or pulse voltage after attracting operation, power consumption of the electromagnetic brake 10 and heat generation of an electromagnetic coil can be reduced.

However, in the above-described brake driving method in related art, if an outer force is applied also to the electromagnetic brake 10 due to an external factor such as a shock given to the movable body while traveling, since the retention voltage of the electromagnet 5 is lower than the attraction voltage, the retention of the armature 3 is released to apply brakes. Moreover, the retaining position of the armature 3 is shifted from a defined position to abnormally wear the pad 4.

When the pad 4 abnormally wears, the position where the outer disk 2 and the pad 4 come into contact with each other becomes away from the electromagnet 5. This makes it difficult to sufficiently attract the armature 3 with the magnetic force occurring from the electromagnet 5 by normal attraction voltage, further wearing away the pad 4 in a vicious circle.

Also, when the electromagnetic brake 10 is driven by a secondary battery, the supplied power supply voltage tends to decrease with a decrease in charging rate of the secondary battery. The voltage value supplied to the electromagnet 5 also decreases to make the retaining operation unstable, possibly causing inconveniences due to a shock or the like.

It is desirable to provide a brake control device, traveling vehicle, brake driving method, and program capable of favorably maintaining a brake release state even if a shock or the like is given to a movable body.

### SUMMARY

According to an aspect of the disclosure, there is provided a brake control device of a non-excitation actuation type mounted on a traveling vehicle to release an electromagnetic brake upon energization of an electromagnet, and the brake control device includes a current quantity control unit which controls a current quantity to be supplied to the electromagnet. The current quantity control unit performs control by an attraction voltage to be applied when the electromagnetic brake is released, a retention voltage to be applied to maintain a release state, and a re-attraction voltage to be applied to readjust a retention state.

According to another aspect of the disclosure, there is provided a brake driving method of a non-excitation actuation type in which a current quantity control unit mounted on a traveling vehicle releases an electromagnetic brake upon energization of an electromagnet. The brake driving method includes: applying, by the current quantity control unit, an attraction voltage for releasing the electromagnetic brake to the electromagnet; applying, by the current quantity control unit, a retention voltage for maintaining a brake release to the electromagnet after the applying the attraction voltage; and applying, by the current quantity control unit, a re-attraction voltage for readjusting a retention state to the electromagnet in a period of the applying the retention voltage.

According to still another aspect of the disclosure, there is provided a program causing a computer to perform operation of releasing an electromagnetic brake upon energization of an electromagnet mounted on a traveling vehicle. The program causes the computer to perform a process including: applying an attraction voltage for releasing the electromagnetic brake to the electromagnet; applying a retention voltage for maintaining a brake release to the electromagnet after the applying the attraction voltage; and applying a re-attraction voltage for readjusting a retention state to the electromagnet in a period of the applying the retention voltage.

### BRIEF DESCRIPTION OF THE DRAWINGS

FIG. 1 is a block diagram of a brake control device in a first embodiment;

FIG. 2 is a block diagram schematically depicting control structure of a current quantity control unit;

FIG. 3A and FIG. 3B are timing diagrams of brake voltage outputted from the current quantity control unit to an electromagnetic brake in the first embodiment, in which FIG. 3A depicts a case of retention by static voltage and FIG. 3B depicts a case of retention by pulse voltage;

FIG. 4 is a flowchart of a control method of the first embodiment;

FIG. 5 is a block diagram of a brake control device in a second embodiment;

FIG. 6A and FIG. 6B are timing diagrams of brake voltage outputted from the current quantity control unit to the electromagnetic brake in the second embodiment, in which FIG. 6A depicts a case at high voltage and FIG. 6B depicts a case at low voltage;

FIG. 7 is a block diagram of a brake control device in a third embodiment;

FIG. 8A and FIG. 8B are timing diagrams of brake voltage outputted from the current quantity control unit to the electromagnetic brake in the third embodiment, in which FIG. 8A depicts outputs from an acceleration sensor and FIG. 8B depicts brake voltage;

FIG. 9 is a flowchart of a control method in the third embodiment;

FIG. 10 is a block diagram of a brake control device in a fourth embodiment;

FIG. 11A and FIG. 11B are timing diagrams of brake voltage outputted from the current quantity control unit to the electromagnetic brake in the fourth embodiment, in which FIG. 11A depicts outputs from a speed sensor and FIG. 11B depicts brake voltage;

FIG. 12 is a flowchart of a control method in the fourth embodiment;

FIG. 13A and FIG. 13B are timing diagrams of brake voltage outputted from the current quantity control unit to the electromagnetic brake in a fifth embodiment, in which FIG. 13A depicts a variance of speed sensor outputs and FIG. 13B depicts brake voltage;

FIG. 14 is a flowchart of a control method in the fifth embodiment;

FIG. 15 is a block diagram of a brake control device in a sixth embodiment;

FIG. 16 is a flowchart of a control method in the sixth embodiment;

FIG. 17 is a schematic plan view of a traveling route of a movable body in a seventh embodiment;

FIG. 18A and FIG. 18B are timing diagrams of brake voltage outputted from the current quantity control unit to the electromagnetic brake in the seventh embodiment, in which FIG. 18A depicts brake voltage and FIG. 18B depicts road surface information along the traveling route;

FIG. 19 is a flowchart of a control method in the seventh embodiment;

FIG. 20 is a schematic diagram of a traveling state of a movable body in an eighth embodiment;

FIG. 21 is a schematic sectional view of the structure of a non-excitation electromagnetic brake suggested in related art; and

FIG. 22A and FIG. 22B depict output voltage from a brake control device to an electromagnet, in which FIG. 22A depicts a case of retention by static voltage and FIG. 22B depicts a case of retention by pulse voltage.

### DESCRIPTION OF THE EMBODIMENTS

### First Embodiment

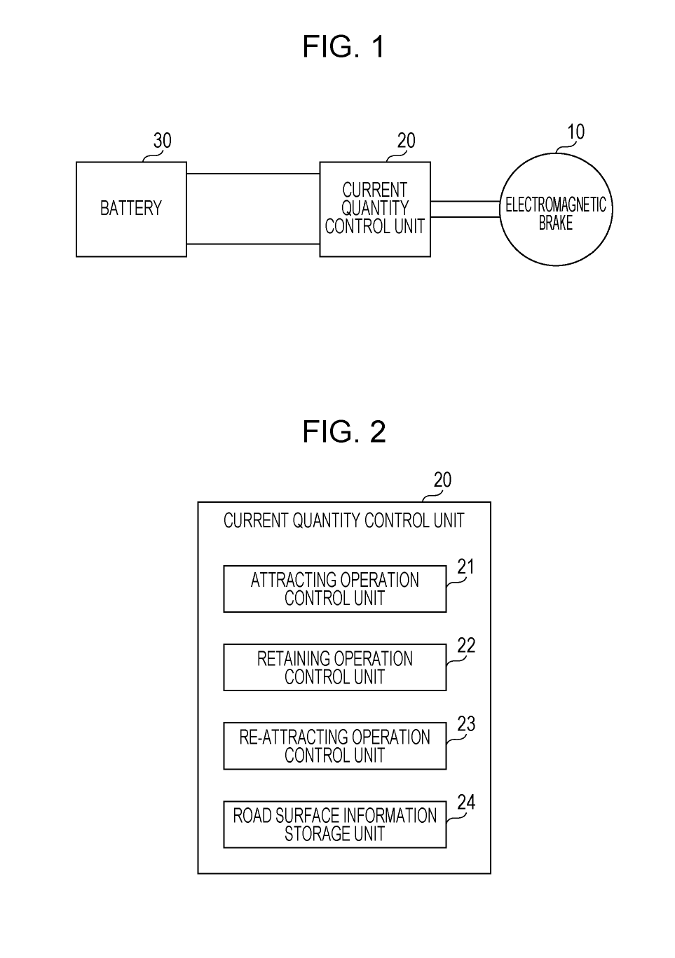

In the following, a first embodiment of the present disclosure is described with reference to the drawings. FIG. 1 is a block diagram of a brake control device in the first embodiment. As depicted in FIG. 1, a movable body includes, as a brake control device, an electromagnetic brake 10, a current quantity control unit 20, and a battery 30. The current quantity control unit 20 is electrically connected to the electromagnetic brake 10. The battery 30 is electrically connected to the current quantity control unit 20.

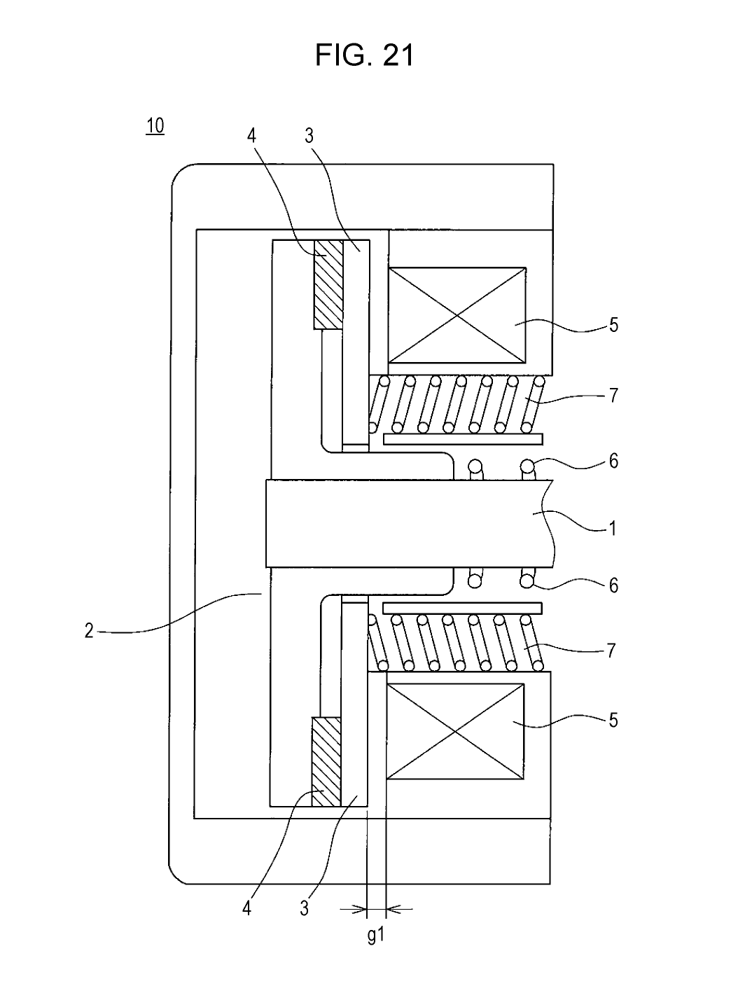

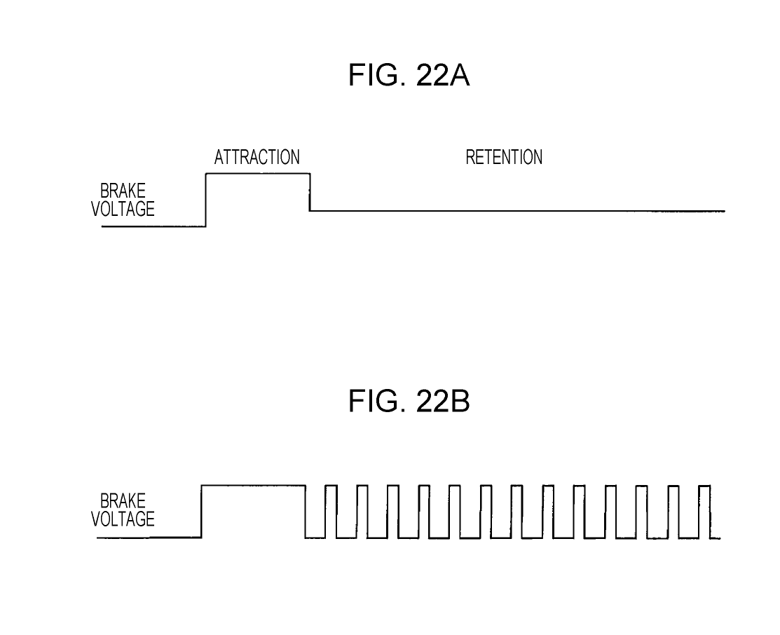

The electromagnetic brake 10 is of a non-excitation type in related art, and one configured as, for example, depicted in FIG. 21, may be used. Also, the shaft 1 of the electromagnetic brake 10 may be an extension of an axle of the movable body or an extension of a rotor of an electric motor as a motive power source.

The current quantity control unit 20 is a device which controls electric power supplied from the battery 30 for supply at a predetermined voltage value to the electromagnetic brake 10. The current quantity control unit 20 can adopt any specific structure capable of performing predetermined information processing and voltage value control by direct-current or alternating-current power from the battery 30, and may include, for example, a voltage stabilizer circuit, a pulse width modulation (PWM) control circuit, a boosting circuit, an information processing device such as a CPU, a storage device, and so forth.

The battery 30 is a device which supplies electric power stored inside to the outside. For example, a secondary battery such as a lithium-ion battery or a fuel cell can be used.

FIG. 2 is a block diagram schematically depicting control structure of the current quantity control unit 20. In the current quantity control unit 20 supplied with electric power from the battery 30, a program for controlling the electromagnetic brake 10 is executed by the information processing device and various circuits. Here, by a combination of the information processing device, various circuits, and the storage device, the current quantity control unit 20 has configured therein an attracting operation control unit 21, a retaining operation control unit 22, a re-attracting operation control unit 23, and a road surface information storage unit 24.

The current quantity control unit 20 supplies the electromagnetic brake 10 with a voltage having a predetermined waveform to adjust and control a current flowing through the electromagnet 5 of the electromagnetic brake 10, thereby controlling the operation of the electromagnetic brake 10. Here, the attracting operation control unit 21, the retaining operation control unit 22, the re-attracting operation control unit 23, and the road surface information storage unit 24 may be each configured as hardware by a dedicated drive circuit or as software by an information processing device such as a CPU.

The attracting operation control unit 21 applies an attraction voltage to the electromagnet 5 for brake release at the time of operation of releasing the electromagnetic brake 10. With the attraction voltage applied to the electromagnet 5, the armature 3 moves to a direction of the electromagnet 5 to cause a brake release state.

The retaining operation control unit 22 applies, to the electromagnet 5, a retention voltage for maintaining a brake release state after release of the electromagnetic brake 10. When the retention voltage is applied to the electromagnet 5, a magnetic force to the extent that a distance between the armature 3 and the electromagnet 5 is retained occurs in the electromagnet 5, retaining the brake release state.

The re-attracting operation control unit 23 applies, to the electromagnet 5, a re-attraction voltage for readjusting the state in which brake release is retained. When the re-attraction voltage is applied to the electromagnet 5, the armature 3 moves in a direction of the electromagnet 5 to readjust the brake release state.

The road surface information storage unit 24 has road surface information along a traveling route recorded on a storage device included in the current quantity control unit 20, and will be described in detail in a seventh embodiment.

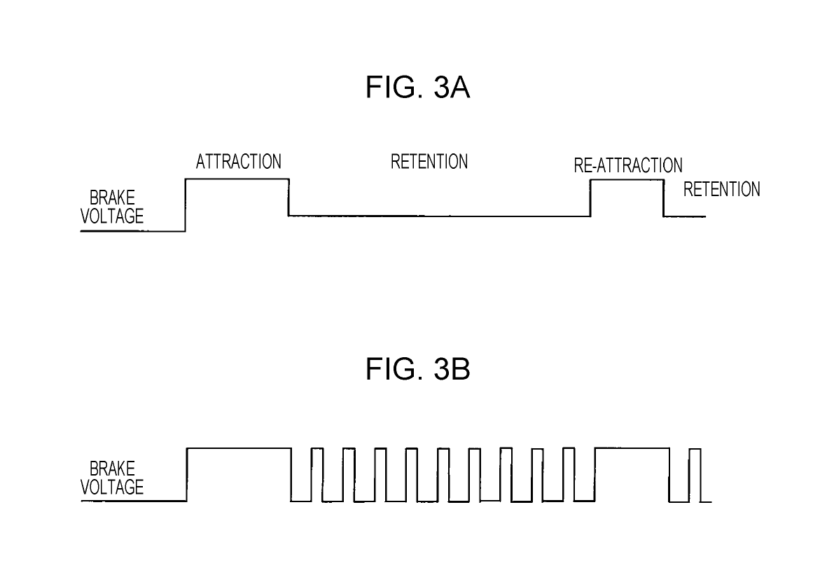

FIG. 3A and FIG. 3B are timing diagrams of brake voltage outputted from the current quantity control unit 20 to the electromagnetic brake 10 in the first embodiment, in which FIG. 3A depicts a case of retention by static voltage and FIG. 3B depicts a case of retention by pulse voltage. While the attraction voltage and the re-attraction voltage are assumed to be supplied steadily in FIG. 3A and FIG. 3B, the attraction voltage and the re-attraction voltage may be taken as pulse voltages to control a magnetic force occurring at the electromagnet 5 per unit time by PWM control. In the retention by the static voltage in FIG. 3A, the current quantity control unit 20 supplies, to the electromagnetic brake 10, a relatively-large attraction voltage at the time of attracting operation of brake release by moving the armature 3 in the direction of the electromagnet 5, then steadily continues to supply thereto a retention voltage lower than the attraction voltage as retaining operation, and supplies a re-attraction voltage higher than the retention voltage in a period of the retaining operation to perform re-attracting operation. Here, the attraction voltage and the re-attraction voltage may have voltage values of the same degree, but the re-attraction voltage may be set lower than the attraction voltage if the re-attraction voltage causes a magnetic force capable of correcting the distance between the armature 3 and the electromagnet 5 at an appropriate position. In FIG. 3A, to move the armature 3 more to the direction of the electromagnet 5 in the re-attracting operation than in the period of the retaining operation, control may be performed so that application of the re-attraction voltage increases the current quantity to be supplied to the electromagnet 5 more than immediately-preceding application of the retention voltage.

In the retention by pulse voltage in FIG. 3B, after supplying a relatively large attraction voltage to the electromagnetic brake 10 at the time of attracting operation, the current quantity control unit 20 continues to supply a pulse voltage as retaining operation, and supplies a re-attraction voltage in a period of retaining operation for a time longer than the pulse width of the retention voltage to perform re-attracting operation. In the retention period of FIG. 3B, the pulse retention voltage has its voltage value and pulse width adjusted by PWM control. A magnetic force occurring from the electromagnet 5 controls the attraction force acting on the armature 3 to retain the distance between the armature 3 and the electromagnet 5 at an appropriate position. Also in FIG. 3B, to move the armature 3 more to the direction of the electromagnet 5 in the re-attracting operation than in the retaining operation, control may be performed so that application of the re-attraction voltage increases the current quantity to be supplied to the electromagnet 5 more than immediately-preceding application of the retention voltage.

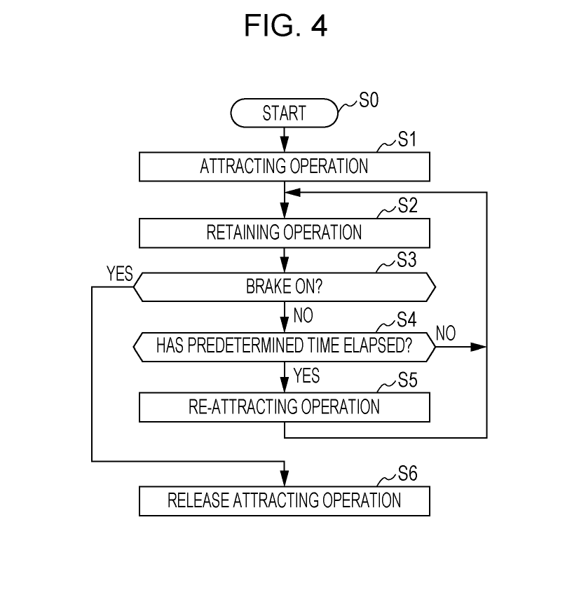

FIG. 4 is a flowchart of a control method of the present embodiment. When an instruction for brake release is transmitted to the current quantity control unit 20 at step S0, the depicted control method is performed by the attracting operation control unit 21, the retaining operation control unit 22, and the re-attracting operation control unit 23 of the current quantity control unit 20, and the information processing device.

Step S1 is an attracting operation step. The attracting operation control unit 21 supplies a relatively-large attraction voltage to the electromagnetic brake 10 for a predetermined period of time, as depicted in FIG. 3A and FIG. 3B, to move the armature 3 in the direction of the electromagnet 5 for brake release.

Step S2 is a retaining operation step. The retaining operation control unit 22 supplies a retention voltage capable of maintaining a brake release state to the electromagnetic brake 10, as depicted in FIG. 3A and FIG. 3B, to maintain the state in which the armature 3 moves to the direction of the electromagnet 5.

Step S3 is a brake determination step of determining the presence or absence of an instruction for brake operation. When an instruction for brake operation is present, the process proceeds to step S6. When an instruction for brake operation is absent, the process proceeds to step S4.

Step S4 is a re-attraction determination step of determining whether to enable re-attracting operation, determining whether a predetermined time has elapsed after the previous attracting operation step or re-attracting operation step. If the predetermined time has elapsed, the process proceeds to step S5. If the predetermined time has not elapsed, the process proceeds to step S2.

Step S5 is a re-attracting operation step. The re-attracting operation control unit 23 supplies, to the electromagnetic brake 10, a re-attraction voltage for a predetermined period of time to make readjustment so that the positional relation between the armature 3 and the electromagnet 5 is in a brake release state as depicted in FIG. 3A and FIG. 3B. After the re-attracting operation step ends, the process proceeds to step S2.

Step S6 is an attracting operation release step, stopping supply of the attraction voltage, the retention voltage, and the re-attraction voltage to the electromagnetic brake 10 to release attraction of the armature 3 by the electromagnet 5. This causes the armature 3 to move to a direction of the outer disk 2 by the elastic force of the spring 7 in the electromagnetic brake 10 to bring the outer disk 2 and the pad 4 into contact with each other to perform braking operation by a friction force.

In FIG. 3A and FIG. 3B, an example is depicted in which the re-attracting operation is performed once in the period of the retaining operation. However, since the period of the retaining operation is a traveling duration of the movable body, the re-attracting operation may be performed a plurality of times. In one example, with a timer incorporated in the current quantity control unit 20, the re-attracting operation may be cyclically performed after the elapse of a predetermined period of time.

As depicted in FIG. 3A and FIG. 3B, in the current quantity control unit 20 of the present embodiment, the re-attracting operation is performed during a duration of retaining operation after attracting operation. Thus, even when a shock or the like is given to the movable body in the period of the retaining operation to increase the distance between the armature 3 and the electromagnet 5 more than a defined retention distance, a magnetic force larger than that at the time of the retaining operation is generated to attract the armature 3 again in the direction of the electromagnet 5, thereby allowing correction to an appropriate position.

Therefore, in the brake control device, brake driving method, and movable body using these of the present embodiment, even if a shock or the like is given to the movable body, the distance between the armature 3 and the electromagnet 5 can be corrected to an appropriate position to favorably maintain the brake release state.

### Second Embodiment

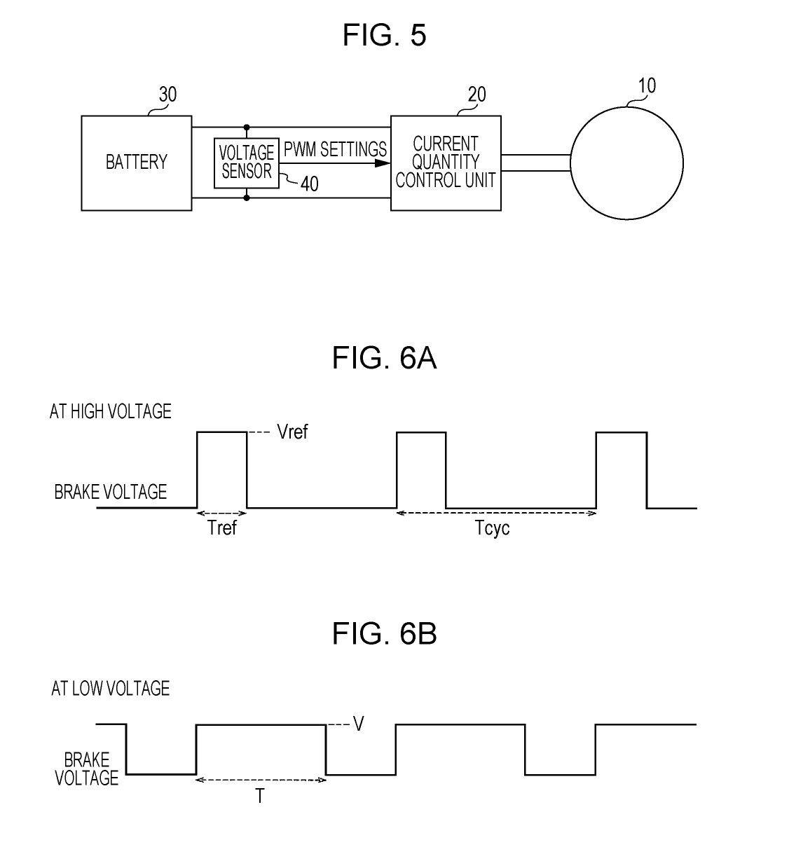

Next, a second embodiment of the present disclosure is described with reference to the drawings. Details overlapping with those of the first embodiment are not described herein. FIG. 5 is a block diagram of a brake control device in the second embodiment. As depicted in FIG. 5, a movable body may include, as a brake control device, the electromagnetic brake 10, the current quantity control unit 20, the battery 30, and a voltage sensor 40. As depicted in FIG. 5, the current quantity control unit 20 is electrically connected to the electromagnetic brake 10, the battery 30 is electrically connected to the current quantity control unit 20, a measurement terminal of the voltage sensor 40 is connected to an output terminal of the battery 30, and the voltage sensor 40 and the current quantity control unit 20 are connected so as to be able to transmit information to and from each other.

The voltage sensor 40 is an example of a traveling state detection unit in the present disclosure, detecting a power supply voltage of the battery 30 fluctuating due to a charging rate when the movable body starts traveling, a traveling duration, a deterioration state, and so forth and transmitting the detected voltage value to the current quantity control unit 20. The current quantity control unit 20 sets parameters for PWM control in accordance with the power supply voltage value transmitted from the voltage sensor 40 to determine a voltage value and a pulse width to be outputted to the electromagnetic brake 10.

FIG. 6A and FIG. 6B are timing diagrams of brake voltage outputted from the current quantity control unit 20 to the electromagnetic brake 10 in the second embodiment, in which FIG. 6A depicts a case at high voltage and FIG. 6B depicts a case at low voltage. Duty ratio control of the brake voltage depicted in FIG. 6A and FIG. 6B can be applied also to any of the attracting operation, the retaining operation, and the re-attracting operation depicted in FIG. 3A and FIG. 3B.

When the battery 30 is almost fully charged and the power supply voltage detected by the voltage sensor 40 is relatively high, brake voltage is supplied from the current quantity control unit 20 to the electromagnetic brake 10 with PWM settings in which a voltage value is Vref, a pulse width is Tref, and a pulse cycle is Tcyc. On the other hand, when the charging rate of the battery 30 is decreased and the power supply voltage detected by the voltage sensor 40 is relatively low, brake voltage is supplied from the current quantity control unit 20 to the electromagnetic brake 10 with PWM settings in which a voltage value is V smaller than Vref, a pulse width is T larger than Tref, and a pulse cycle is Tcyc.

Here, for a duty ratio for PWM control, the following relation holds: T=Tref×Vref/V. This maintains the current consumed in the electromagnetic brake 10 as being stabilized, and also maintains the attracting force of the armature 3 by the electromagnet 5 as being stabilized at high voltage depicted in FIG. 6A and at low voltage depicted in FIG. 6B.

Therefore, in the brake control device, brake driving method, and movable body using these of the present embodiment, even if the power supply voltage of the battery 30 fluctuates, the distance between the armature 3 and the electromagnet 5 can be corrected to an appropriate position to favorably maintain the brake release state.

### Third Embodiment

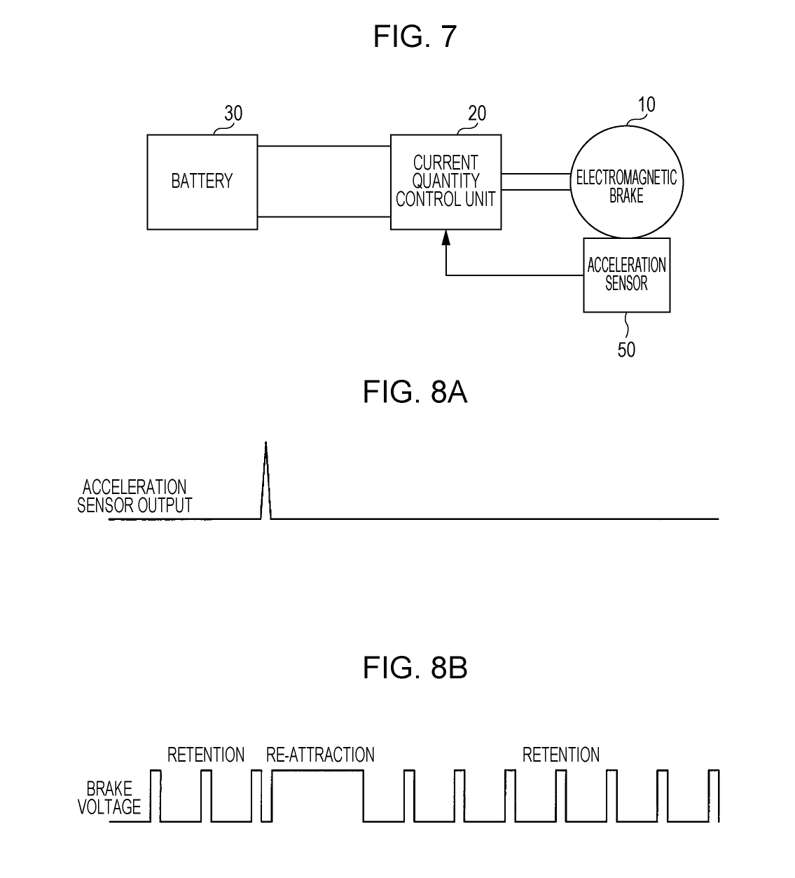

Next, a third embodiment of the present disclosure is described with reference to the drawings. Details overlapping with those of the first embodiment are not described herein. FIG. 7 is a block diagram of a brake control device in the third embodiment. As depicted in FIG. 7, a movable body may include, as a brake control device, the electromagnetic brake 10, the current quantity control unit 20, the battery 30, and an acceleration sensor 50. As depicted in FIG. 7, the current quantity control unit 20 is electrically connected to the electromagnetic brake 10, the battery 30 is electrically connected to the current quantity control unit 20, the acceleration sensor 50 is provided near the electromagnetic brake 10, and the acceleration sensor 50 and the current quantity control unit 20 are connected so as to be able to transmit information to and from each other.

The acceleration sensor 50 is an example of the traveling state detection unit in the present disclosure. As the acceleration sensor 50, a triaxial acceleration sensor or the like using a micro electro mechanical system (MEMS) in related art can be used, transmitting the detected acceleration to the current quantity control unit 20.

FIG. 8A and FIG. 8B are timing diagrams of brake voltage outputted from the current quantity control unit 20 to the electromagnetic brake 10 in the third embodiment, in which FIG. 8A depicts outputs from an acceleration sensor and FIG. 8B depicts brake voltage. When a shock or the like is given to the electromagnetic brake 10 of the movable body, the acceleration sensor 50 detects a rapid change in acceleration as depicted in FIG. 8A. When the detected acceleration value transmitted from the acceleration sensor 50 in the period of retaining operation exceeds a predetermined threshold, the current quantity control unit 20 performs re-attracting operation.

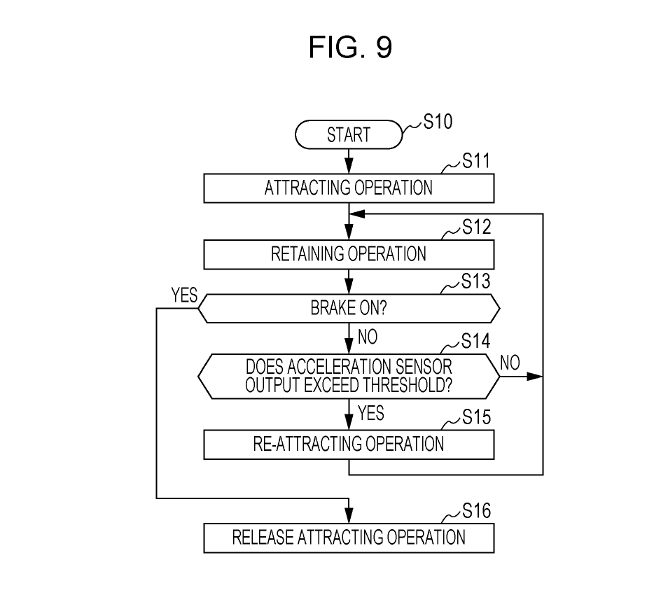

FIG. 9 is a flowchart of a control method in the present embodiment. In the control method of the present embodiment, a condition for determination at the re-attraction determination step is different from that of the first embodiment depicted in FIG. 4. Of steps S10 to S16, only step S14 as a re-attraction determination step is different from that of the first embodiment, and the other common steps are not described herein.

Step S14 is a re-attraction determination step of determining whether to enable re-attracting operation, determining whether an output from the acceleration sensor 50 exceeds the threshold. When the output exceeds the threshold, the process proceeds to step S15. When the output does not exceed the threshold, the process proceeds to step S12.

In a situation in which an abrupt change in acceleration is detected by the acceleration sensor 50, there is a high possibility that a shock is given to the electromagnetic brake 10 to cause the armature 3 to be shifted from a predetermined retention position. Therefore, also in the present embodiment, re-attracting operation is performed immediately after a change in acceleration is detected, thereby allowing the armature 3 to be quickly attracted again to the direction of the electromagnet 5 and corrected to an appropriate position. In the present embodiment, re-attraction is performed immediately after a shock is given to the electromagnetic brake 10, thereby allowing a reduction of a period of time in which the armature 3 is shifted from the appropriate retention position to minimize abnormal wear of the pad 4. Also, since re-attracting operation is not cyclically performed, an increase in power consumption due to re-attracting operation can be reduced.

Note that while the re-attracting operation is cyclically performed, re-attracting operation by using the acceleration sensor 50 detecting an acceleration can be performed in a supplemental manner. This allows a positional shift of the armature 3 to be corrected even if the acceleration sensor 50 makes an erroneous detection, thereby achieving more reliably control.

### Fourth Embodiment

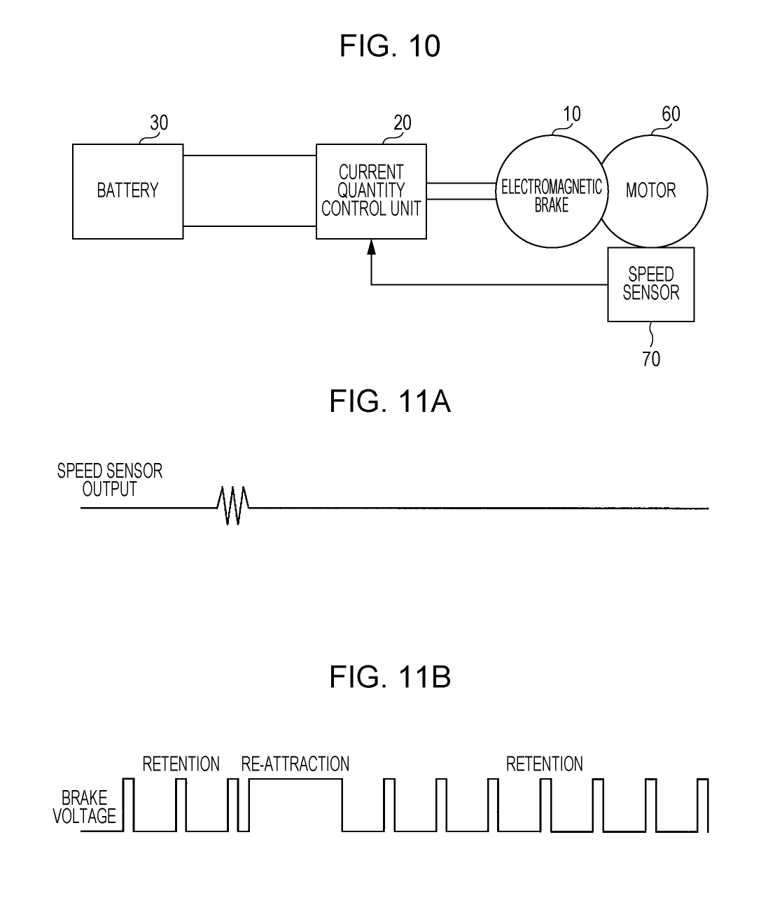

Next, a fourth embodiment of the present disclosure is described with reference to the drawings. Details overlapping with those of the first embodiment are not described herein. FIG. 10 is a block diagram of a brake control device in the fourth embodiment. As depicted in FIG. 10, a movable body may include, as a brake control device, the electromagnetic brake 10, the current quantity control unit 20, the battery 30, a motor 60, and a speed sensor 70. As depicted in FIG. 10, the current quantity control unit 20 is electrically connected to the electromagnetic brake 10, the battery 30 is electrically connected to the current quantity control unit 20, the speed sensor 70 is provided near the motor 60, and the speed sensor 70 and the current quantity control unit 20 are connected so as to be able to transmit information to and from each other.

The motor 60 serves as an electric motor, which is a motive power source of the movable body, and drives a wheel of the movable body. The speed sensor 70 is an example of a the traveling state detection unit in the present disclosure, such as an encoder provided to the motor 60 to measure a rotation speed of the motor 60. When the motor 60 rotates to cause the movable body to travel, the speed sensor 70 detects the number of revolutions of the motor 60 and the speed of the movable body, and transmits the detected number of revolutions and the detected speed to the current quantity control unit 20.

FIG. 11A and FIG. 11B are timing diagrams of brake voltage outputted from the current quantity control unit 20 to the electromagnetic brake 10 in the fourth embodiment, in which FIG. 11A depicts outputs from the speed sensor and FIG. 11B depicts brake voltage. When a shock or the like is given to the movable body, the speed sensor 70 detects a change in speed as depicted in FIG. 11A. When a speed change quantity transmitted from the speed sensor 70 in the period of retaining operation exceeds a predetermined threshold, the current quantity control unit 20 performs re-attracting operation.

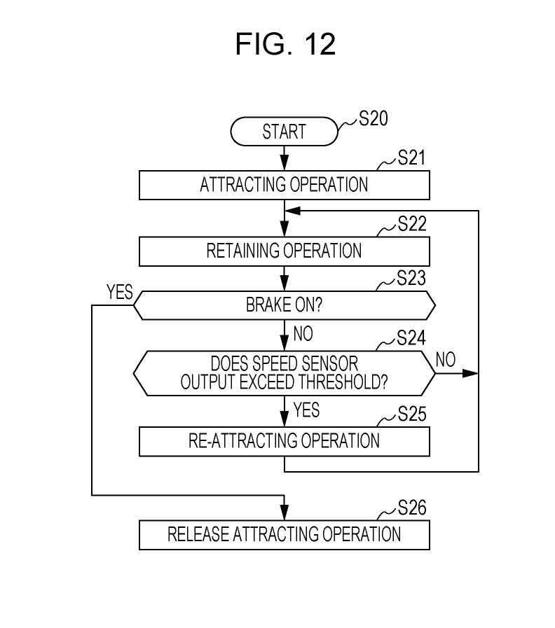

FIG. 12 is a flowchart of a control method in the present embodiment. In the control method of the present embodiment, a condition for determination at the re-attraction determination step is different from that of the first embodiment depicted in FIG. 4. Of steps S20 to S26, only step S24 as a re-attraction determination step is different from that of the first embodiment, and the other common steps are not described herein.

Step S24 is a re-attraction determination step of determining whether to enable re-attracting operation, determining whether an output from the speed sensor 70 exceeds the threshold. When the output exceeds the threshold, the process proceeds to step S25. When the output does not exceed the threshold, the process proceeds to step S22.

In a situation in which a large change quantity of speed is detected by the speed sensor 70, there is a high possibility that a shock is given to the movable body and the electromagnetic brake 10 to cause the armature 3 to be shifted from a predetermined retention position. Therefore, also in the present embodiment, re-attracting operation is performed immediately after a change quantity of speed exceeds the threshold, thereby allowing the armature 3 to be quickly attracted again to the direction of the electromagnet 5 and corrected to an appropriate position.

Also in the present embodiment, with the use of the detection result of the speed sensor 70 such as an encoder included in the motor 60, no additional acceleration sensor is provided, thereby allowing a reduction in the number of components and weight.

### Fifth Embodiment

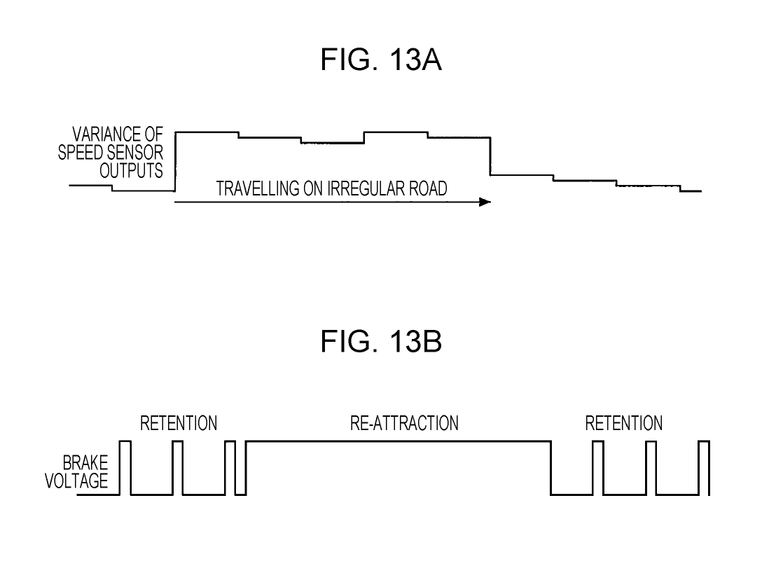

Next, a fifth embodiment of the present disclosure is described with reference to the drawings. Details overlapping with those of the fourth embodiment are not described herein. FIG. 13A and FIG. 13B are timing diagrams of brake voltage outputted from the current quantity control unit 20 to the electromagnetic brake 10 in the fifth embodiment, in which FIG. 13A depicts a variance of speed sensor outputs and FIG. 13B depicts brake voltage.

Also in the present embodiment, with the use of the speed sensor 70 depicted in FIG. 10, detection values of the speed sensor 70 are sectioned in predetermined cycles, and a variance of speeds in each section is calculated, as depicted in FIG. 13A. When the variance value of the speeds exceeds a predetermined threshold, the current quantity control unit 20 continues the re-attracting operation.

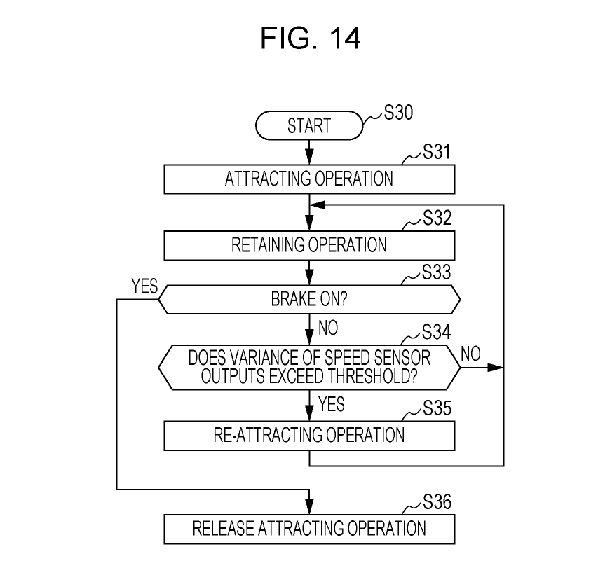

FIG. 14 is a flowchart of a control method in the present embodiment. In the control method of the present embodiment, a condition for determination at the re-attraction determination step is different from that of the first embodiment depicted in FIG. 4. Of steps S30 to S36, only step S34 as a re-attraction determination step is different from that of the first embodiment, and the other common steps are not described herein.

Step S34 is a re-attraction determination step of determining whether to enable re-attracting operation, determining whether a variance of outputs from the speed sensor 70 exceeds the threshold. When the variance exceeds the threshold, the process proceeds to step S35. When the variance does not exceed the threshold, the process proceeds to step S32.

When a road surface where the movable body travels is an irregular road surface, the speed of the movable body becomes nonuniform due to a shock to the wheels, and the variance tends to increase. Therefore, the current quantity control unit 20 assumes, from the variance of the speeds measured by the speed sensor 70, that the road surface is in a state of an irregular road surface, and continues the re-attracting operation. This allows the armature 3 not to be shifted from a predetermined position, and the brake release state can be favorably maintained.

While the example in FIG. 13B depicts that the retaining operation and the re-attracting operation have the same voltage value, the duty ratio regarding voltage values, pulse widths, and so forth can be switched in a stepwise manner in accordance with the magnitude of the variance of the speeds to allow a further reduction in power consumption.

### Sixth Embodiment

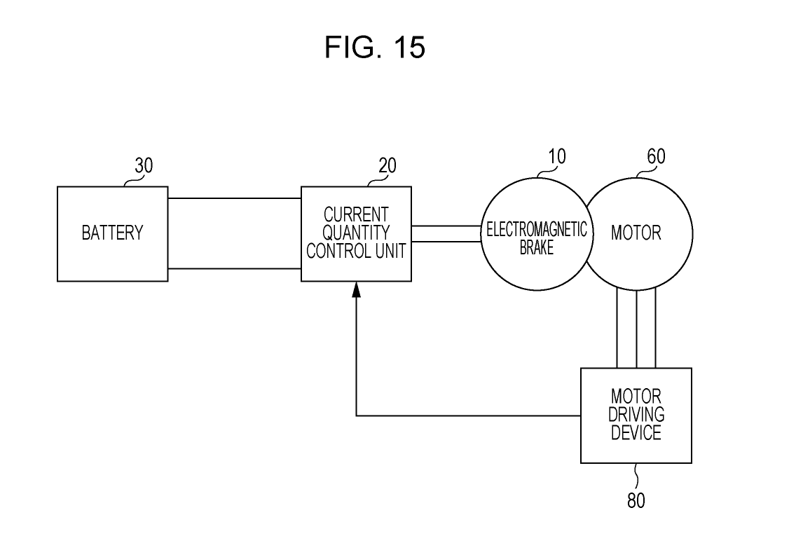

Next, a sixth embodiment of the present disclosure is described with reference to the drawings. Details overlapping with those of the fourth embodiment are not described herein. FIG. 15 is a block diagram of a brake control device in the sixth embodiment. As depicted in FIG. 15, a movable body may include, as a brake control device, the electromagnetic brake 10, the current quantity control unit 20, the battery 30, the motor 60, and a motor driving device 80. As depicted in FIG. 15, the current quantity control unit 20 is electrically connected to the electromagnetic brake 10, the battery 30 is electrically connected to the current quantity control unit 20, the motor driving device 80 is electrically connected to the motor 60, and the motor driving device 80 and the current quantity control unit 20 are connected so as to be able to transmit information to and from each other.

In the present embodiment, the motor 60 is, for example, a DC brushless motor, and is driven by electric power and a signal supplied from the motor driving device 80. The motor driving device 80 performs drive control over the motor 60 and simultaneously can detect the speed of the movable body by calculating the number of revolutions of the motor 60, and thus corresponds to the traveling state detection unit of the present disclosure. In one example of a method of calculating the number of revolutions of the motor 60 by using the motor driving device 80, a Hall effect sensor or the like provided to the motor 60 is used. In another example, sensor-less driving for calculating the speed by using an electromotive force or the like of the motor 60 can be used.

The motor driving device 80 detects the speed of the movable body from the number of revolutions of the motor 60, and transmits the detection result to the current quantity control unit 20. An output of the brake voltage from the current quantity control unit 20 to the electromagnetic brake 10 is similar to that described by using FIG. 11A and FIG. 11B in the fourth embodiment and FIG. 13A and FIG. 13B in the fifth embodiment.

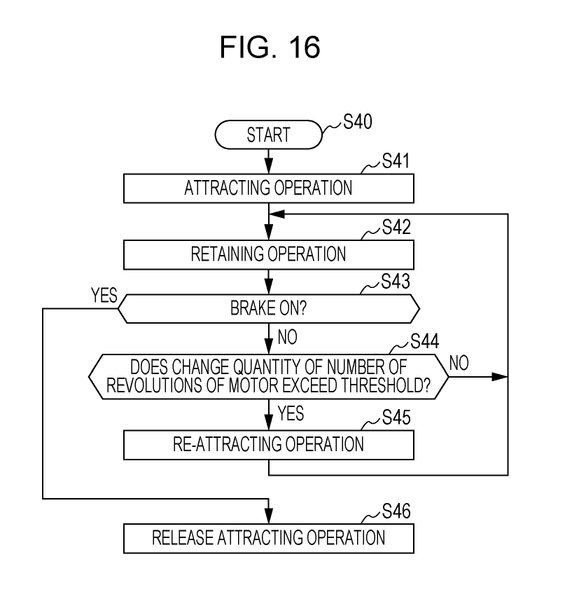

FIG. 16 is a flowchart of a control method in the present embodiment. In the control method of the present embodiment, a condition for determination at the re-attraction determination step is different from that of the first embodiment depicted in FIG. 4. Of steps S40 to S46, only step S44 as a re-attraction determination step is different from that of the first embodiment, and the other common steps are not described herein.

Step S44 is a re-attraction determination step of determining whether to enable re-attracting operation, determining whether a change quantity of the number of revolutions of the motor 60 calculated by the motor driving device 80 exceeds a threshold. When the change quantity exceeds the threshold, the process proceeds to step S45. When the change quantity does not exceed the threshold, the process proceeds to step S42.

In the present embodiment, with the use of the functions of the motor driving device 80, the number of revolutions of the motor 60 can be detected and the speed of the movable body can be calculated. Thus, no additional speed sensor is provided, thereby allowing a reduction in the number of components and weight.

As depicted in FIG. 11A and FIG. 11B, when the re-attracting operation is performed immediately after the change quantity of the speed exceeds the threshold, the armature 3 can be quickly attracted again to the direction of the electromagnet 5 and corrected to an appropriate position. Also, as depicted in FIG. 13A and FIG. 13B, when the current quantity control unit 20 assumes, from the variance of the speeds measured by the speed sensor 70, that the road surface is in a state of an irregular road surface and continues the re-attracting operation, the armature 3 is not shifted from a predetermined position, and the brake release state can be favorably maintained.

### Seventh Embodiment

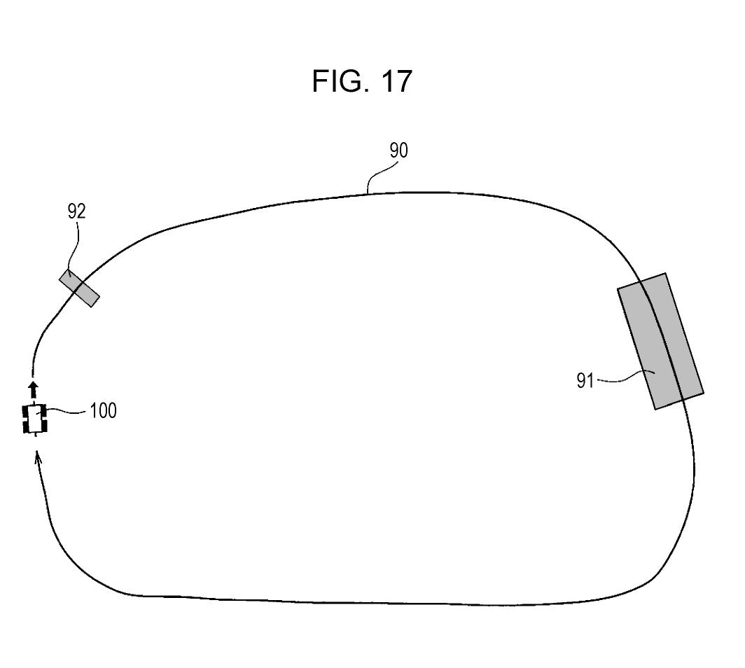

Next, the seventh embodiment of the present disclosure is described with reference to the drawings. Details overlapping with those of the first embodiment are not described herein. FIG. 17 is a schematic plan view of a traveling route of a movable body in the seventh embodiment.

In the present embodiment, it is assumed that a traveling route 90 where a movable body 100 travels is predetermined and the positions of an irregular road surface 91 and a step 92 that are present on the traveling route 90 are notified in advance. The movable body 100 includes the electromagnetic brake 10, the battery 30, and the current quantity control unit 20 of the present disclosure. Also, on a storage device of the current quantity control unit 20, road surface information along the traveling route 90 may be recorded to configure the road surface information storage unit 24 as depicted in FIG. 2.

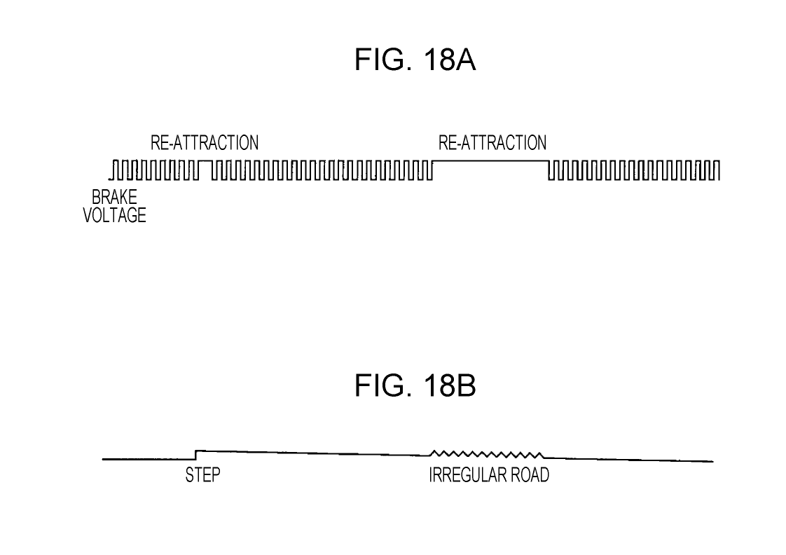

FIG. 18A and FIG. 18B are timing diagrams of brake voltage outputted from the current quantity control unit 20 to the electromagnetic brake 10 in the seventh embodiment, in which FIG. 18A depicts brake voltage and FIG. 18B depicts road surface information along the traveling route.

When the road surface information depicted in FIG. 18B is recorded on the road surface information storage unit 24, the current quantity control unit 20 measures a traveling distance of the movable body 100 and position information by the global positioning system (GPS) in advance, grasping the position where the movable body 100 is traveling on the traveling route 90. When determining that the movable body 100 is traveling on a leveled road surface on the traveling route 90, the current quantity control unit 20 performs normal retaining operation. When determining that the movable body 100 is traveling on the step 92 or the irregular road surface 91, the current quantity control unit 20 performs re-attracting operation. Here, as depicted in FIG. 18A, when the movable body 100 is traveling on the step 92, the re-attracting operation is completed within a short period of time. While the movable body 100 is traveling on the irregular road surface 91, the current quantity control unit 20 continues re-attracting operation.

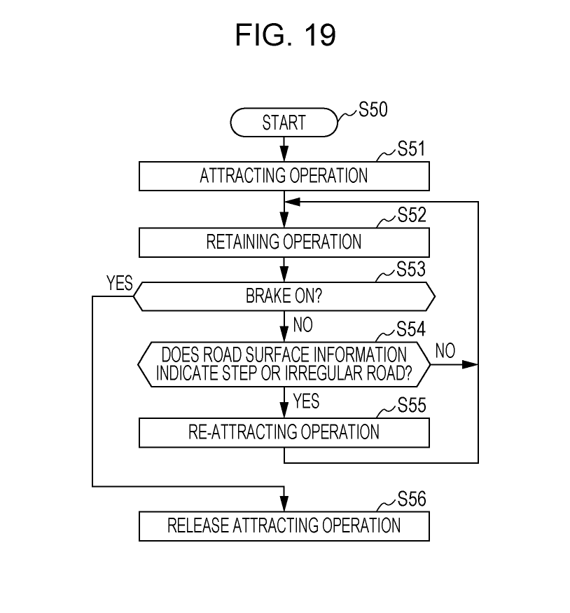

FIG. 19 is a flowchart of a control method in the present embodiment. In the control method of the present embodiment, a condition for determination at the re-attraction determination step is different from that of the first embodiment depicted in FIG. 4. Of steps S50 to S56, only step S54 as a re-attraction determination step is different from that of the first embodiment, and the other common steps are not described herein.

Step S54 is a re-attraction determination step of determining whether to enable re-attracting operation, determining whether the road surface information at the position where the movable body 100 is traveling on the traveling route 90 indicates the step 92 or the irregular road surface 91. When the road surface information indicates the step 92 or the irregular road surface 91, the process proceeds to step S55. When the road surface information indicates a leveled road surface, the process proceeds to step S52.

In the present embodiment, re-attracting operation is performed by using the road surface information along the traveling route 90 recorded in advance in the road surface information storage unit 24. This allows the size of the step 92 or a shock on the irregular road surface 91 to be predicted in advance, and re-attracting operation can be performed for a minimum period of time at an appropriate timing immediately before or after a shock is given to the electromagnetic brake 10. Thus, even if a shock or the like is given to the movable body 100, the distance between the armature 3 and the electromagnet 5 can be corrected to an appropriate position, and the brake release state can be favorably maintained. Also, the duration of the re-attracting operation can be minimized to reduce power consumption.

Also, in the retaining operation and the re-attracting operation, the voltage values and the pulse widths of the outputs from the current quantity control unit 20 to the electromagnetic brake 10 may be finely set in accordance with the road surface information. This allows optimization of power consumption for favorably maintaining the brake release state.

While the example has been described in which the road surface information along the traveling route 90 is recorded on the road surface information storage unit 24 of the current quantity control unit 20, the road surface information may be recorded on a server device provided outside of the movable body 100, for example, an operator room, and the current quantity control unit 20 may acquire the road surface information from the server device via information communication unit in a wired or wireless manner.

### Eighth Embodiment

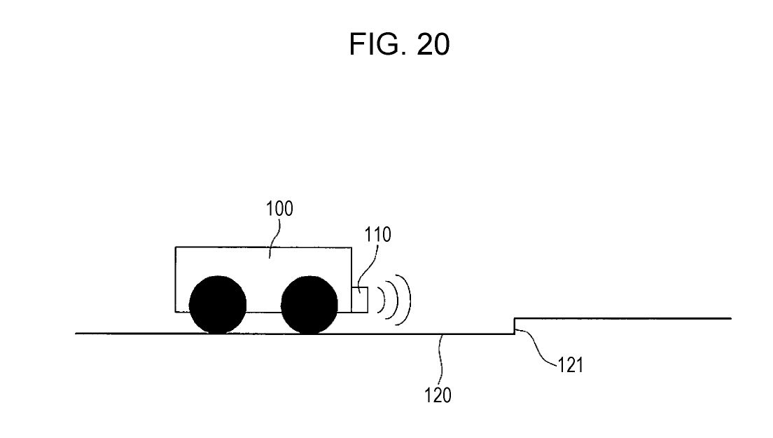

Next, an eighth embodiment of the present disclosure is described with reference to the drawings. Details overlapping with those of the first embodiment are not described herein. FIG. 20 is a schematic diagram of a traveling state of a movable body in the eighth embodiment.

In the present embodiment, an obstruction sensor 110 may be attached in a forward direction of the movable body 100 to detect a step 121 or an obstruction that is present ahead on a road surface 120 where the movable body 100 travels. The obstruction sensor 110 is an example of the traveling state detection unit in the present disclosure. For example, a measurement device using infrared rays or the like can be used, detecting a distance to the obstruction and transmitting obstruction detection information to the current quantity control unit 20. Also, an image capturing device (camera) may be used as the obstruction sensor 110 to detect an obstruction or a traveling state by image processing or the like.

Upon receiving the obstruction detection information detected by the obstruction sensor 110, the current quantity control unit 20 calculates a timing when the wheels overpass the obstruction based on the detected distance to the obstruction and the speed of the movable body 100, and continues retaining operation before and after that timing.

In the present embodiment, the re-attracting operation is performed when the obstruction sensor 110 detects an obstruction to calculate a timing when a shock is given at the time of overpassing the obstruction, and the re-attracting operation can be performed for a minimum period of time at an appropriate timing immediately before or after a shock is given to the electromagnetic brake 10. Thus, even if a shock or the like is given to the movable body 100, the distance between the armature 3 and the electromagnet 5 can be corrected to an appropriate position, and the brake release state can be favorably maintained. Also, the duration of the re-attracting operation can be minimized to reduce power consumption.

When the obstruction sensor 110 is attached only to the forward direction of the movable body 100, a step detection using the obstruction sensor 110 may be performed at the time of forwarding, and the re-attracting operation may continue when the movable body 100 moves to a direction outside a detection area by the obstruction sensor 110, such as at the time of reversing or movement to turning or the like. This allows a reduction in the number of obstruction sensors 110 to be mounted, thereby reducing the number of components and weight of the movable body 100.

The present disclosure contains subject matter related to that disclosed in Japanese Priority Patent Application JP 2017-045900 filed in the Japan Patent Office on Mar. 10, 2017), the entire contents of which are hereby incorporated by reference.

Note that the embodiments disclosed herein are exemplary in all respects, and do not serve as a basis for restrictive interpretation. Therefore, the technical range of the present disclosure is not interpreted only based on the embodiments described above, but is defined based on the scope of the appended claim. Also, the present disclosure includes all modifications within the meaning and scope of equivalents of the appended claims.

What is claimed is:

1. A brake control device of a non-excitation actuation type mounted on a traveling vehicle to release an electromagnetic brake upon energization of an electromagnet, the brake control device comprising:
a current quantity control unit which controls a current quantity to be supplied to the electromagnet, wherein
the current quantity control unit performs control by
an attraction voltage to be applied when the electromagnetic brake is released,
a retention voltage to be applied to maintain a release state, and
a re-attraction voltage to be applied to readjust a retention state.

2. The brake control device according to claim 1, wherein
the current quantity control unit performs the control so that application of the re-attraction voltage increases the current quantity to be supplied to the electromagnet more than immediately-preceding application of the retention voltage.

3. The brake control device according to claim 1, further comprising:
a traveling state detection unit which detects a traveling state of the traveling vehicle, wherein
the current quantity control unit performs the current quantity control in accordance with the detection result of the traveling state detection unit.

4. The brake control device according to claim 3, wherein
the traveling state detection unit is a voltage sensor which detects a voltage supplied to the brake control device.

5. The brake control device according to claim 3, wherein
the traveling state detection unit is an acceleration sensor.

6. The brake control device according to claim 3, wherein
the traveling state detection unit is a speed sensor.

7. The brake control device according to claim 6, wherein
when a variance of detection values of the speed sensor is larger than a predetermined quantity, the current quantity control unit performs the current quantity control by applying the re-attraction voltage.

8. The brake control device according to claim 3, wherein
the traveling state detection unit is an obstruction sensor.

9. The brake control device according to claim 3, wherein
the traveling state detection unit is an image capturing device.

10. The brake control device according to claim 1, further comprising:
a route surface information storage unit which previously stores road surface information along a traveling route, wherein
the current quantity control unit performs the current quantity control based on the road surface information.

11. A traveling vehicle comprising:
the brake control device according to claim 1.

12. A brake driving method of a non-excitation actuation type in which a current quantity control unit mounted on a traveling vehicle releases an electromagnetic brake upon energization of an electromagnet, the brake driving method comprising:
applying, by the current quantity control unit, an attraction voltage for releasing the electromagnetic brake to the electromagnet;
applying, by the current quantity control unit, a retention voltage for maintaining a brake release to the electromagnet after the applying the attraction voltage; and
applying, by the current quantity control unit, a re-attraction voltage for readjusting a retention state to the electromagnet in a period of the applying the retention voltage.

13. A non-transitory computer-readable medium that stores a program causing a computer to perform operation of releasing an electromagnetic brake upon energization of an electromagnet mounted on a traveling vehicle, the program causing the computer to perform a process comprising:
applying an attraction voltage for releasing the electromagnetic brake to the electromagnet;
applying a retention voltage for maintaining a brake release to the electromagnet after the applying the attraction voltage; and
applying a re-attraction voltage for readjusting a retention state to the electromagnet in a period of the applying the retention voltage.
